(19) United States
(12) Patent Application Publication
(10) Pub. No.: US 2021/0097878 A1
(43) Pub. Date: Apr. 1, 2021

(54) LEARNING SCHEDULE GENERATION DEVICE, METHOD AND PROGRAM

(71) Applicant: NIPPON TELEGRAPH AND TELEPHONE CORPORATION, Tokyo (JP)

(72) Inventors: Midori KODAMA, Musashino-shi, Tokyo (JP); Ippei SHAKE, Musashino-shi, Tokyo (JP); Takahiro HATA, Musashino-shi, Tokyo (JP)

(73) Assignee: NIPPON TELEGRAPH AND TELEPHONE CORPORATION, Tokyo (JP)

(21) Appl. No.: 16/971,204

(22) PCT Filed: Feb. 21, 2019
(86) PCT No.: PCT/JP2019/006602

§ 371 Date: Aug. 19, 2020

(30) Foreign Application Priority Data
Feb. 23, 2018 (JP) 2018-031052

(51) Int. Cl. G09B 7/04; G09B 5/10

(52) U.S. Cl. CPC G09B 7/04; G06Q 50/205; G09B 5/10

(57) ABSTRACT

A learning schedule of a user is generated on the basis of information indicating a learning history of the user. A question answer data acquisition section (111) acquires the information. indicating the learning history of a user (j), a time-series understanding level calculation section (1131) calculates a time-series understanding level of the user (j) for a learning item (s) on the basis of the information indicating the learning history of the learning item (s) of the user (j) and information indicating a difficulty level of a question according to the learning item (s) answered by the user (j), a model generation section (1132) generates an understanding level transition model according to the user (j) for the learning item (s) by performing function approximation of transition data of the calculated understanding level according to the learning item (s) of the user (j) per unit time, and a learning schedule generation section (114) generates a learning schedule of the user (j) on the basis of the understanding level transition model according to the user (j).

### TECHNICAL FIELD

The present invention relates to a learning schedule generation apparatus, a learning schedule generation method, and a learning schedule generation program for generating a learning schedule of a user on the basis of information indicating a learning history of the user.

### BACKGROUND ART

In recent years, a system that supports a learner or a learning coach with use of a processing terminal has been known. As such system, for example, a learning supporting system in which a learner can input an answer with use of a tablet terminal and know the score results is known (for example, see NPL 1).

Meanwhile, it is known that the understanding degrees of the learners can be measured and compared among the learners without the need for the learners to take the same test by simultaneously handling the features (difficulty levels) of the answered questions of the questions for the plurality of students and the ability of the students (for example, NPL 2). A learning system that presents a question with the difficulty level corresponding to the estimated understanding level of the learner by using a method of estimating the understanding level as above is also known (for example, see NPL 3).

### CITATION LIST

### Non Patent Literature

[NPL 1] Youji Ochi, Katsuya Ide. “Tablet Typed Testing System with Choice Code Recognition” Transactions of Japanese Society for Information and Systems in Education 32.1 (2015) : 37-47.
[NPL 2] Yuki Tsukihara, Keiichi Suzuki, Hideo Hirose. “A small implementation case of the mathematics tests with the Item Response Theory evaluation into an e-learning system.” Computer & Education 24 (2008) : 70-76.
[NPL 3] Chen, Chih-Ming, Hahn-Ming Lee, and Ya-Hui Chen. “Personalized e-learning system using item response theory.” Computers & Education 44.3 (2005) : 237-255.
[NPL 4] Hideyo Takeuchi, Masahiro Hoguro, and Taizo Umezaki. “A pitch extraction method with high frequency resolution for singing evaluation”. IEEJ Transactions on Electronics, Information and Systems. Vol. 129.10 (2009): 1889-1901.

### SUMMARY OF THE INVENTION

### Technical Problem

However, while the learning efficiency per time spent by the user for learning can be increased with the method of presenting a question in accordance with the understanding level of the user as described in NPL 3, the learning time necessary for the user to achieve the learning goal cannot be estimated, for example. Presenting a learning schedule to the user is useful for providing an aim of learning as above to the user.

With methods in which the user makes a plan by estimating the time assumed to be necessary in order for the user to achieve the goal by him- or herself as those that have been hitherto performed, the user cannot estimate the understanding degree very well by him- or herself. Therefore, the user cannot estimate how much he or she can understand with how much time. Even when the understanding degree of the user is objectively grasped with a test or the like, the understanding level changes daily in accordance with the learning, and hence it is difficult to estimate the necessary learning time as described above.

The present invention has been made in view of the abovementioned situation, and an object thereof is to provide a learning schedule generation apparatus, a learning schedule generation method, and a learning schedule generation program capable of generating a learning schedule of a user on the basis of information indicating a learning history of the user.

### Means for Solving the Problem

In order to solve the abovementioned problem, a first aspect of the present invention is a learning schedule generation. apparatus, including: an understanding level transition model generation section that generates an understanding level transition model according to a user on basis of information indicating a learning history of the user including identification information of a question answered by the user and information on a timing at which the question is answered by the user, and information indicating a difficulty level of the question; and a learning schedule generation section that generates a learning schedule of the user on basis of the generated understanding level transition model.

In a second aspect of the present invention, the learning schedule generation apparatus further includes: a question answer data acquisition section that acquires question answer data including identification information of a question answered by a plurality of users and information on whether answers by the plurality of users in the question are right or wrong; and a question difficulty level calculation section that calculates the difficulty level of the question on basis of the information on whether the answers by the plurality of users in the question are right or wrong included in the acquired question answer data.

In a third aspect of the present invention, in the learning schedule generation apparatus, the information indicating the learning history further includes identification information of a learning item corresponding to the question, the understanding level transition model generation section generates an understanding level transition model indicating a time transition of an understanding level of the user for the learning item for each learning item, and the learning schedule generation section includes: an allocation time calculation section that calculates time allocated to learning of each learning item that maximizes a total degree of improvement of the understanding level of the user for each learning item on basis of a degree of improvement of the understanding level of the user with respect to learning time for each learning item indicated by the generated understanding level transition model for each learning item, and information indicating learnable time of the user set in advance, and a generation section that generates a learning schedule of the user on basis of the calculated time allocated to the learning of each learning item.

In a fourth aspect of the present invention, in the learning schedule generation apparatus, the information indicating the learning history further includes identification information of a learning item corresponding to the question, the understanding level transition model generation section generates an understanding level transition model indicating a time transition of an understanding level of the user for the learning item for each learning item, and the learning schedule generation section includes: an allocation time calculation section that calculates time allocated to learning of each learning item so as to minimize a total difference between the understanding level of the user for each learning item and a goal understanding level set in advance on basis of an understanding level after improvement of the understanding level of the user with respect to learning time for each learning item indicated by the generated understanding level transition model for each learning item, and information indicating learnable time of the user set in advance; and a generation section that generates a learning schedule of the user on basis of the calculated time allocated to the learning of each learning item.

In a fifth aspect of the present invention, in the learning schedule generation apparatus, the information indicating the learnable time of the user set in advance includes information on learnable time for the user for each day set in advance, the allocation time calculation section calculates time allocated to the learning of each learning item for each day further on basis of a value of a learning for rate for each day and information on the learnable time of the user for each day set in advance, and the generation section generates the learning schedule of the user on basis of the calculated time allocated to the learning of each learning item for each day.

In a sixth aspect of the present invention, in the learning schedule generation apparatus, the learning schedule generation section further includes an understanding level improvement degree calculation section that calculates an understanding level improvement degree presumed to be obtained when the calculated time allocated to the learning of each learning item is spent on the learning with use of the generated understanding level transition model of the learning item for each learning item, and the generation section generates the learning schedule of the user on basis of the understanding level improvement degree that is presumed to be obtained when the time allocated to the learning of each learning item is spent on the learning and that is calculated for each learning item.

### Effects of the Invention

According to the first aspect of the present invention, by generating the understanding level transition model with use of an indication in which the daily understanding level of the user that is the learning history is reflected, the change of the understanding level of the user over time can be reflected in the generated understanding level transition model. By using the learning schedule generated as above, the user can accurately estimate the necessary learning time for achieving the goal, for example.

According to the second aspect of the present invention, the objective difficulty level calculated with use of the problem answer data according to the plurality of users for the problem answered by the user can be reflected.

According to the third aspect of the present invention, by using the generated learning schedule, the user can perform learning that maximizes the total degree of improvement of the understanding level for each learning item within a limited learnable time. In this way, the learning effect of the user in certain periods of time such as units of weeks of months can be maximized toward the purpose.

According the fourth aspect of the present invention, by using the generated learning schedule, the user can perform learning that causes the understanding level of the user for each learning item to become as closer to the understanding level set in advance as possible within a limited learnable time. In this way, the learning effect of the user in certain periods of time such as units of weeks of months can be maximized toward the purpose.

According to the fifth aspect of the present invention, in the generated learning schedule, the daily change of the understanding level of the user due to the learning forgetting rate for each day can be reflected.

According to the sixth aspect of the present invention, in the generated learning schedule, the learning item of which understanding level improvement degree at the time of learning is large can be learned in a prioritized manner, or the learning item of which understanding level improvement degree at the time of learning is large can be can be learned in a period that is as late as possible, to thereby cause the forgetting of the learning item to be difficult, for example.

In other words, according to each aspect of the present invention, the learning schedule generation apparatus, the learning schedule generation method, and the learning schedule generation program capable of generating the learning schedule of the user on the basis of the information indicating the learning history of the user can be provided.

### BRIEF DESCRIPTION OF DRAWINGS

FIG. 1 is a block diagram illustrating a function configuration of a learning schedule generation apparatus according to Embodiment 1 of the present invention.

FIG. 2 is a flowchart illustrating one example of learning schedule generation processing executed by a control unit of the learning schedule generation apparatus illustrated in FIG. 1.

### DESCRIPTION OF EMBODIMENTS

Embodiments according to the present invention are described below with reference to the drawings.

### Embodiment 1

### (Configuration)

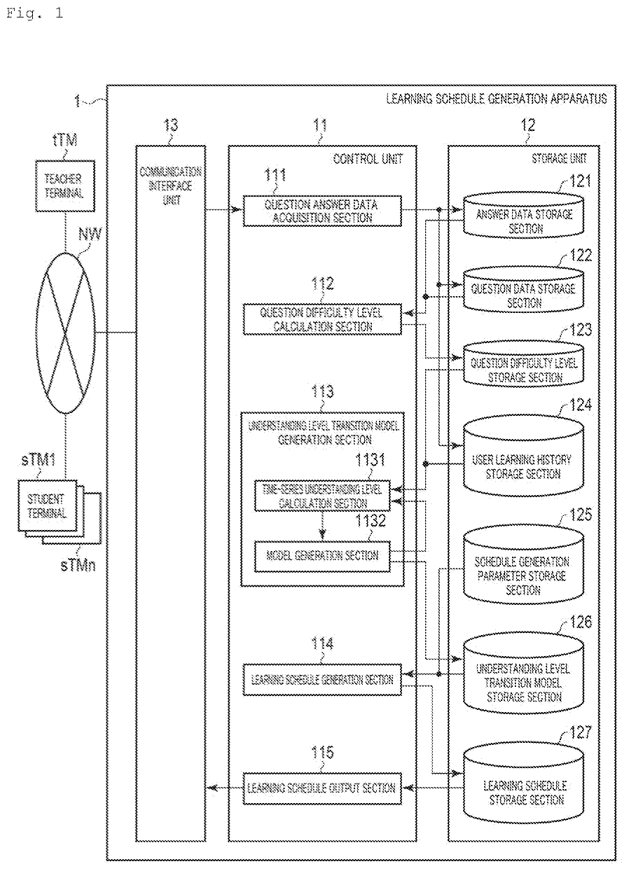

FIG. 1 is a block diagram illustrating a function configuration of a learning schedule generation apparatus 1 according to Embodiment 1 of the present invention.

First, on a teacher terminal tTM or student terminals sTM1 to sTMn that are PC terminals including a smartphone or a tablet type, for example, a question is given to a user that is a student, and the user inputs an answer for the question on his or her own terminal out of the student terminals sTM1 to sTMn. Question answer data answered by the user is transmitted to the learning schedule generation apparatus 1 via a communication network NW.

The learning schedule generation apparatus 1 can acquire the transmitted question answer data, generate a learning schedule of the user on the basis of the learning history of the user including the question answer data, and output the learning schedule. As a result, the user is presented with an optimal learning schedule directed toward the purpose.

FIG. 1 illustrates an example in which one teacher terminal tTM and the plurality of students terminals sTM1 to sTMn can be connected over the communication network NW, but a plurality of teacher terminals may be connectable to the communication network NW.

The learning schedule generation apparatus 1 includes a control unit 11, a storage unit 12, and a communication interface unit 13 as hardware.

The communication interface unit 13 includes one or more wired or wireless communication interface units, for example.

The communication interface unit 13 inputs the question data, the question answer data, the information indicating the learning history of the user, an unoccupied time schedule as the learnable time of the user, and schedule generation parameters transmitted from the teacher terminal tTM or the student terminals sTM1 to sTMn to the control unit 11. The communication interface unit 13 transmits information indicating the learning schedules of the users output from the control unit 11 to the student terminals sTM1 to sTMn.

The question answer data includes identification information (ID) of the user, user attribute information such as the grade and the gender of the user, identification information (ID) of the question answered by the user, information on whether the answer by the user according to the question is right or wrong, information on the timing at which the user has answered the question, information on the time taken by the user to answer the question, and information on content of the answer by the user according to the question, for example.

The question data includes identification information (ID) of the question, attribute information of the question such as the subject, the target grade, the unit, the teaching material name, and the number of choices to which the question corresponds, and information on the content of the question, for example.

The schedule generation parameters are parameters used when the learning schedule is generated.

The storage unit 12 uses a nonvolatile memory that is writable and readable at any time such as an HDD (Hard Disc Drive) or an SSD (Solid State Drive) as a storage medium, and includes an answer data storage section 121, a question data storage section 122, a question difficulty level storage section 123, a user learning history storage section 124, a schedule generation parameter storage section 125, an understanding level transition model storage section 126, and a learning schedule storage section 127 in order to realize this embodiment.

The answer data storage section 121 is used to store the question answer data according to a freely-selected user therein.

The question data storage section 122 is used to store the question data therein.

The question difficulty level storage section 123 is used to store therein data indicating the difficulty levels of the questions.

The user learning history storage section 124 is used to store therein the question answer data transmitted from the student terminals sTM1 to sTMn and the information indicating the learning history of the user as information indicating the learning history for each user. The information indicating the learning history for each user may be stored in an apparatus different from the learning schedule generation apparatus 1.

The schedule generation parameter storage section 125 stores therein the schedule generation parameters and the unoccupied time schedule for each user. The schedule generation parameters and the unoccupied time schedule for each user may be input to the student terminals sTM1 to sTMn in advance and acquired by an acquisition section (not shown) included in the control unit 11, for example.

The understanding level transition model storage section 126 is used to store therein the understanding level transition model according to the user.

The learning schedule storage section 127 is used to store therein the learning schedule of the user.

The control unit 11 includes a question answer data acquisition section 111, a question difficulty level calculation section 112, an understanding level transition model generation section 113, a learning schedule generation section 114, and a learning schedule output section 115 in order to execute processing functions in this embodiment.

The control unit 11 may include a hardware processor such as a CPU (Central Processing Unit), and a program memory, and may implement the processing functions in the sections above by causing the hardware processor to execute a program stored in the program memory. In this case, those processing functions do not necessarily need to be implemented with use of the program stored in the program memory, and may be implemented with use of a program provided through a network.

The question answer data acquisition section 111 executes processing of acquiring question answer data according to a freely-selected user from a freely-selected terminal out of the student terminals sTM1 to sTMn via the communication interface unit 13 and storing the acquire question answer data in the answer data storage section 121 of the storage unit 12.

The question answer data acquisition section 111 executes processing of acquiring the question data from the teacher terminal tTM via the communication interface unit 13 and storing the acquired question data in the question data storage section 122 of the storage unit 12. The processing of acquiring the question data may acquire the question data from the database in advance.

The question difficulty level calculation section 112 executes processing of reading out the question answer data according to the plurality of users stored in the answer data storage section 121 of the storage unit 12. The question difficulty level calculation section 112 executes processing of reading out the question data corresponding to the ID of the question according to the read out question answer data stored in the question data storage section 122 of the storage unit 12. Then, the question difficulty level calculation section 112 executes processing of calculating the difficulty levels of the questions on the basis of the read out question answer data and question data and storing the information indicating the calculated difficulty levels of the questions in the question difficulty level storage section 123 of the storage unit 12. In the processing of calculating the difficulty levels of the questions, the information indicating the calculated difficulty levels of the questions maybe stored in the question difficulty level storage section 123 after being linked to the corresponding attribute information of the questions.

The question answer data acquisition section 111 executes processing of acquiring information indicating the learning history of the user including one or more question answer data or sequentially acquire the question answer data from freely-selected terminals out of the teacher terminal tTM or the student terminals sTM1 to sTMn via the communication interface unit 13 and storing the information indicating the learning history of the user and the question answer data that have been acquired in the user learning history storage section 124 of the storage unit 12 as information indicating the learning history including one or more question answer data for each user. In the processing of acquiring the information indicating the learning history of the user, information indicating the learning histories of a plurality of users may be acquired at once as the information indicating the learning history of the user. In the processing of storing the information indicating the learning history for each user in the user learning history storage section 124, the information indicating the learning history maybe sequentially stored for each user as described above each time the information indicating the learning history of the user or the question answer data is acquired by the question answer data acquisition section 111.

The understanding level transition model generation section 113 includes a time-series understanding level calculation section 1131 and a model generation section 1132.

The time-series understanding level calculation section 1131 executes processing of reading out the information indicating the learning history of the user stored in the user learning history storage section 124 of the storage unit 12. The time-series understanding level calculation section 1131 executes processing of reading out information indicating the difficulty level of the question answered by the user corresponding to the information indicating the learning history of the user from the question difficulty level storage section 123 of the storage unit 12. Then, the time-series understanding level calculation section 1131 executes processing of calculating a time-series understanding level according to the learning of the user on the basis of the information indicating the learning history of the user and the information indicating the difficulty level of the question answered by the user that have been read out.

The model generation section 1132 executes processing of generating an understanding level transition model indicating the time transition of the understanding level of the user by performing function approximation of the transition data of the understanding level per unit time according to the learning of the user that has been calculated and storing the generated understanding level transition model in the understanding level transition model storage section 126 of the storage unit 12.

The processing of calculating the time-series understanding level and the processing of generating the understanding level transition model may be executed for each of learning items with questions of which attribute information is different from each other. In this case, first, in the processing of calculating the time-series understanding level, the read out information indicating the learning history of the user is divided so that the question answer data included in the information indicating the learning history of the user is separated in accordance with the learning item, and the time-series understanding level is calculated for each learning item on the basis of the information indicating the learning history divided in accordance with the learning item. Next, in the processing of generating the understanding level transition model, the understanding level transition model is generated for each learning item on the basis of the transition data of the calculated understanding level per unit time for each of the learning items. The processing of dividing the information indicating the learning history is implemented with use of the attribute information of the questions according to the question answer data included in the information indicating the learning history by referring to the question data stored in the question data storage section 122. Alternatively, the processing of dividing the information indicating the learning history may be implemented with use of the attribute information of the questions stored in the question difficulty level storage section 123 by being linked to the difficulty levels of the questions.

The learning schedule generation section 114 executes processing of reading out parameters used for generating the unoccupied time schedule and the learning schedule according to the user stored in the schedule generation parameter storage section 125 of the storage unit 12. The learning schedule generation section 114 executes processing of reading out the understanding level transition model according to the user stored in the understanding level transition model storage section 126 of the storage unit 12. Then, the learning schedule generation section 114 executes processing of generating the learning schedule of the user on the basis of the parameters used for generating the unoccupied time schedule and the learning schedule according to the user and the understanding level transition model according to the user that have been read out. Then, the learning schedule generation section 114 executes processing of storing the generated learning schedule in the learning schedule storage section 127 of the storage unit 12.

The learning schedule output section 115 executes processing of reading out the learning schedule of the user stored in the learning schedule storage section 127 of the storage unit 12 and transmitting information indicating the read out learning schedule of the user to the terminal used by the user out of the student terminals sTM1 to sTMn.

(Operation)

Next, the operation of the learning schedule generation apparatus 1 formed as above is described.

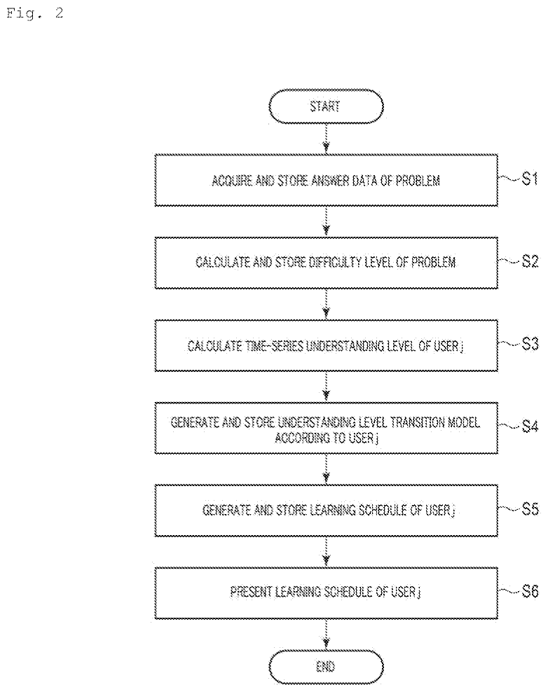

FIG. 2 is a flowchart illustrating one example of learning schedule generation processing executed by the control unit 11 of the learning schedule generation apparatus 1 illustrated in FIG. 1.

Before the processing in Step S1, the teaching material is displayed and a question is presented on the student terminals sTM1 to sTMn for the users that are students, and the users input answers for the question in their own terminals out of the student terminals sTM1 to sTMn. The display and the presentation of the teaching material on the student terminals sTM1 to sTMn is executed in accordance with the input to the teacher terminal tTM by the teacher, for example. Alternatively, when the question data according to the question presented by the teacher is stored in the question data storage section 122 of the learning schedule generation apparatus 1 or a database different from the learning schedule generation apparatus 1 in advance, for example, the display and the presentation of the teaching material on the student terminals sTM1 to sTMn may be implemented by the learning schedule generation apparatus 1 or the database with the input to the teacher terminal tTM by the teacher serving as a trigger.

In Step S1, the question answer data acquisition section 111 of the control unit 11 acquires the question answer data according to a freely-selected user from a freely-selected terminal out of the student terminals sTM1 to sTMn, and stores the acquired question answer data in the answer data storage section 121.

The question answer data acquisition section 111 acquires the information indicating the learning history of the user from the freely-selected terminal out of the student terminals sTM1 to sTMn, and stores the acquired information indicating the learning history of the user in the user learning history storage section 124 for each user.

Next, in Step S2, the question difficulty level calculation section 112 of the control unit 11 reads out the question answer data according to all users as the plurality of users stored in the answer data storage section 121, and reads out the question data corresponding to the ID of the question according to the read out question answer data stored in the question data storage section 122. Then, the question difficulty level calculation section 112 calculates the difficulty level of the question on the basis of the read out question answer data and question data, and stores the information indicating the calculated difficulty level of the questions in the question difficulty level storage section 123. In the processing in Step S2, the difficulty level calculation processing for questions of which difficulty levels are already stored in the question difficulty level storage section 123 may be omitted.

In Step S3, the time-series understanding level calculation section 1131 of the control unit 11 reads out information indicating the learning history of a user j stored in the user learning history storage section 124, and reads out the information indicating the difficulty level of the question answered by the user j corresponding to the information indicating the learning history of the user j from the question difficulty level storage section 123. Then, the time-series understanding level calculation section 1131 calculates the time-series understanding level of the user j for a learning item s on the basis of information indicating the learning history of the learning item s of the user j and information indicating the difficulty level of the question according to the learning item s answered by the user j out of the read out information indicating the learning history of the user j.

In Step S4, the model generation section 1132 of the control unit 11 performs function approximation of the transition data of the calculated understanding level according to the learning item s of the user j per unit time, generates an understanding level transition model indicating the time transition of the understanding level of the user j for the learning item s, and stores the generated understanding level transition model in the understanding level transition model storage section 126.

The processing in Step S3 and Step S4 may be omitted when the understanding level transition model according to the user j for the learning item s is already stored in the understanding level transition model storage section 126.

In Step S5, the learning schedule generation section 114 of the control unit 11 reads out parameters used for generating the unoccupied time schedule and the learning schedule according to the user j stored in the schedule generation parameter storage section 125. The learning schedule generation section 114 reads out the understanding level transition model according to the user j stored in the understanding level transition model storage section 126. Then, the learning schedule generation section 114 generates the learning schedule of the user j on the basis of the parameters used for generating the unoccupied time schedule and the learning schedule according to the user and the understanding level transition model according to the user j that have been read out. Then, the learning schedule generation section 114 stores the generated learning schedule of the user j in the learning schedule storage section 127.

In Step S6, the learning schedule output section 115 of the control unit. 11 reads out the learning schedule of the user j stored in the learning schedule storage section 127, and transmits information indicating the read out learning schedule of the user j to a student terminal sTMj used by the user j. As a result, the learning schedule is presented to the user j.

The question difficulty level calculation processing in Step S2, the time-series understanding level calculation processing in Step S3, the understanding level transition model generation processing in Step S4, and the learning schedule generation processing in Step S5 are described in detail below.

(1) Question Difficulty Level Calculation Processing

The question difficulty level calculation section 112 calculates the difficulty levels of the questions with use of the question answer data according to the plurality of users stored in the answer data storage section 121 and the question data stored in the question data storage section 122, and stores the information indicating the calculated difficulty levels of the questions in the question difficulty level storage section 123.

The question answer data includes the identification information (ID) of the user, the user attribute information such as the grade and the gender of the user, the identification information (ID) of the question answered by the user, the information on whether the answer by the user according to the question is right or wrong, the information on the timing at which the question is answered by the user, the information on the time taken by the user to answer the question, and the information on the content of the answer by the user according to the question, for example.

The question data includes the identification information (ID) of the question, the attribute information of the question such as the subject, the target grade, the unit, the teaching material name, and the number of choices to which the question corresponds, and the information on the content of the question, for example.

As described in NPL 2, the difficulty levels of the questions can be calculated with use of an IRT method such as Formula (1) and Formula (2), for example.

Formula (1) expresses a probability P_{i,j} of a certain student j answering a question i correctly in accordance with a learning level θⱼ and question parameters (an identification rate aᵢ, a difficulty level bᵢ, and a conjecture cᵢ). In Formula (1), a constant term for causing the value of a logistic model to be closer to the value of a cumulative normal model is represented by D. By using an EM algorithm using a marginal maximum likelihood estimation method for the learning level θⱼ of each student and the parameters aᵢ, bᵢ, and cᵢ of the questions with which a log-likelihood function logL in Formula (2) becomes the maximum, the parameters can be determined from data indicating that the certain student j has answered the question i correctly (u_{i,j}=1) or answered the question i incorrectly (u_{i,j}=0) stored in the answer data storage section 121. The difficulty level of the question is acquired by the parameter bᵢ.

$$\begin{matrix} [ Formula 1 ] & \\ {P}_{i , j} = {c}_{ i} + \frac{( 1 - {c}_{i} )}{1 + exp ( - {Da}_{i} ( {θ}_{j} - {b}_{i} ) )} & ( 1 ) \\ [ Formula 2 ] & \\ log L ( {u}_{i , j} \vert {θ}_{j} , {a}_{i} , {b}_{i} , {c}_{i} ) = {\sum }_{i} {\sum }_{j} {u}_{i , j} log {P}_{i , j} + ( 1 - {u}_{i , j} ) log ( 1 - {P}_{i , j} ) & ( 2 )\end{matrix}$$

A 1-parameter model, a 2-parameter model, or other models may be used instead of the 3-parameter model expressed by Formula (1) and Formula (2). The parameter estimation methods not only include the EM algorithm using the marginal maximum likelihood estimation method but also includes a Bayesian inference method and other estimation methods. When the Bayesian inference is used, the understanding level acquired by the understanding level time transition model can be used as a prior probability.

When the IRT method is used, all of the question answer data stored in the answer data storage section 121 may be calculated by the IRT method at once, or the question answer data may be divided in accordance with the attribute of the question data such as the target grade and the divided question answer data may be calculated by the IRT method each time.

In the two types of methods described above, the question answer data according to the user that has solved only a number of questions that is less than a number set in advance and the question answer data according to a question solved only by a number of users that is less than a number or a rate set in advance may be removed from the question answer data used in the difficulty level calculation in advance.

When calculation is performed by the IRT method, a parameter c may be fixed in advance. For example, when the question i is a multiple-choice question in which an answer is selected from a number of m choices, the value of the parameter c may be fixed to 1/m or a predetermined value in advance.

By the methods above, the question difficulty level calculation section 112 calculates the difficulty levels of the questions and stores the information indicating the calculated difficulty levels of the questions in the question difficulty level storage section 123. The data stored in the question difficulty level storage section 123 includes the ID of the question, the identification rate aᵢ, the difficulty level bᵢ, and the conjecture cᵢ, for example.

(2) Time-Series Understanding Level Calculation Processing

The time-series understanding level calculation section 1131 calculates the time-series understanding level from the information indicating the difficulty levels of the questions stored in the question difficulty level storage section 123 and the information indicating the learning history of the user j stored in the user learning history storage section 124, and outputs the calculated time-series understanding level to the model generation section 1132.

The time-series understanding level is calculated by the following method, for example.

The information indicating the learning history of the learning item s of the user j stored in the user learning history storage section 124 is divided for each calculation unit time t (for example, one day) of the time-series understanding level. The information referred to as a learning history Dj,s,t. The identification rate aᵢ, the difficulty level bᵢ, and the conjecture cᵢ in Formula (3) are read out from the question difficulty level storage section 123, and numerical values according to the question answer data included in the learning history D_{j,s,t} is substituted for u_{i,j} in Formula (4). With use of a Newton-Raphson method, θ_{j,s,t} with which the log-likelihood function logL in Formula (4) becomes the maximum estimated. For the algorithm of the maximum likelihood estimation, a steepest descent method and a quasi-Newton method (including a DFP method, a BFGS method, Broyden's method, and a SR1 method) can be used besides the Newton-Raphson method.

$$\begin{matrix}[ Formula 3 ] & \\ {P}_{i , j} = {c}_{i} + \frac{( 1 - {c}_{i} )}{1 + exp ( - {Da}_{i} ( {θ}_{j , s , t} - {b}_{i} ) )} & ( 3 ) \\ [ Formula 4 ] & \\ log L ( {u}_{i , j} \vert {θ}_{j , s , t} , {a}_{i} , {b}_{i} , {c}_{i} ) = \\ {\sum }_{i} {\sum }_{j} {u}_{i , j} log {P}_{i , j} + ( 1 - {u}_{i , j} ) log ( 1 - {P}_{i , j} ) & ( 4 )\end{matrix}$$

The series of θ_{j,s,t} is output to the model generation section 1132 as the time-series understanding level of the user j.

In the time-series understanding level calculation, the following processing may be performed.

When a test information amount Iₜ defined in advance falls below a threshold α or when the number of the learning histories falls below a threshold β, it is possible to not calculate θ_{j,s,t}, or θ_{j,s,t} may be used in the calculation of θ_{j,s,t+1} by being combined with data of the next unit time. When the model expressed by Formula (3) and Formula (4) is used, the test information amount of θ_{j,s,t} can be calculated by Formula (5) :

$$\begin{matrix}[ Formula 5 ] \\ & \\ I ( {θ}_{j , s , t} ) = - E [ \frac{{\partial }^{2} log L}{\partial {θ}_{j , s , t}^{2}} ] = {\sum }_{t = 1}^{l} {D}^{2} {{a}_{l}^{2} [ \frac{{P}_{ij} - {c}_{i}}{1 - {c}_{i}} ]}^{2} \frac{1 - {P}_{ij}}{{P}_{ij}} & ( 5 )\end{matrix}$$

where E[ ] represents an expected value in [ ].

(3) Understanding Level Transition Model Generation Processing

The model generation section 1132 generates a function model from the time-series understanding level θ_{j,s}(t) of the user j, and stores the generated function model in the understanding level transition model storage section 126.

The function model includes the polynomial expression in Formula (6), the logarithmic function in Formula (7), and the exponential function in Formula (8), for example.

$$\begin{matrix}[ Formula 6 ] & \\ {f}_{θ js} ( t ) = {\sum }_{k = 0}^{m} {w}_{k} {t}^{k} & ( 6 ) \\ [ Formula 7 ] & \\ {f}_{θ js} ( t ) = {w}_{0} log ( a t - {w}_{1} ) + {w}_{2} & ( 7 ) \\ [ Formula 8 ] & \\ {f}_{θ js} ( t ) = {w}_{0} {e}^{ut - ws} + {w}_{2} & ( 8 )\end{matrix}$$

The function model can be described with a distributed autoregressive model (ARCH model), a GARCH model in which the ARCH model is generalized, and the like in addition to an autoregressive model (AR model), a moving-average model (MA model), an autoregressive moving-average model (ARMA model), and an autoregressive integrated moving-average model (ARIMA model).

Out of those functions, the model with the smallest RMSE error only needs to be selected. The error can be evaluated with methods such as MAE and MSE besides the RMSE.

The model generation section 1132 generates the understanding level transition model according to the user j by the methods above, and stores the generated understanding level transition model in the understanding level transition model storage section 126. The understanding level transition model storage section 126 includes data such as the ID of the user, the function expression, and the coefficient value, for example.

(4) Learning Schedule Generation Processing

The learning schedule generation section 114 generates a learning schedule from the understanding level transition model according to the user j stored in the understanding level transition model storage section 126, and the unoccupied time schedule of the user j and the schedule generation parameters according to the user j stored in the schedule generation parameter storage section 125, and stores the generated learning schedule in the learning schedule storage section 127.

An unoccupied schedule of the user j input to the student terminal sTMj by the user j in advance is stored in the schedule generation parameter storage section 125. When the unoccupied schedule it input, an acquisition section (not shown) included in the control unit 11 may cause input screens to be presented on the student terminals sTM1 to sTMn, to thereby prompt the input. The unoccupied schedule includes information such as the date and the unoccupied time (XX:XX to XX:XX).

The schedule generation parameters that are input from the student terminals sTM1 to sTMn or the teacher terminal TM are stored in the schedule generation parameter storage section 125. When the schedule generation parameters according to the users are to be input, the acquisition section (not shown) included in the control unit 11 may cause input screens to be presented on the student terminals sTM1 to sTMn, to thereby prompt the input. When there are no schedule generation parameters according to the users, the learning schedule generation section 114 may set a common specified value (default value) for all of the users. As the schedule generation parameters, items such as the target subject, the mode, the deadline, the goal parameter, and the subject weighting parameter are presumed to be obtained, for example. As the values corresponding to the target subject, for each subject, 1 is input when the subject is the target of the schedule generation and 0 is input when the subject is not the target of the schedule generation, for example. As the mode, any one of modes such as understanding level maximization, weak point overcome, and subject weighting is selected. The subject weighting parameters can be input from the student terminals sTM1 to sTMn or the teacher terminal tTM for each learning item. As the deadline, the date that is the deadline for achieving the goal is input. As the goal parameters, the goal understanding levels for the learning contents or the deviation value of the understanding levels for all of the users can be input from the student terminals sTM1 to sTMn or the teacher terminal tTM, for example.

<4-1 Period>

The number of days until the deadline set by the user j is referred to as T. When the deadline is set and the number of days T until the deadline does not exceed a reference period Tmax (for example, two weeks), the schedule generation is executed so that the learning achievements are maximized within the deadline. When T exceeds the reference period Tmax, the schedule generation is executed so that the learning achievements are maximized in Tmax.

<4-2 Subject>

The schedule is optimized for the target subjects input to the schedule generation parameters. When there is a subject without a learning history in the target subjects included in the schedule generation parameters, a warning may be issued by displaying an indication indicating that the learning history does not exist on the student terminal.

<4-3 Calculation of Time Allocated to Learning Items>

The time allocated to the learning items is calculated by a method below for each mode.

(Understanding Level Maximization Mode)

In an understanding level maximization mode, the schedule is optimized so that an evaluation value G indicating the understanding level improvement of the entire target subject defined by Formula (9) is maximized with the condition in Formula (10). Now, a learning item included in the target subject is represented by s, and the number of types of s is represented by S. An estimated understanding level of the user for the learning item s is represented by

θ̅_{j,s} [Formula 9]

, the total time specified by the unoccupied schedule until the deadline T (or the reference period Tmax) set by the user j is represented by H, and the total amount of the time allocated to the learning items s is represented by hₛ.

$$\begin{matrix} [ Formula 10 ] & \\ G = {\sum }_{s = 1}^{s} ( {\overline{θ}}_{j , s} ( {t}_{0} + {h}_{s} ) - {θ}_{j , s} ( {t}_{0} ) ) = {\sum }_{s = 1}^{s} ( {f}_{θ js} ( {t}_{0} + {h}_{s} ) - {f}_{θ js} ( {t}_{0} ) ) & ( 9 ) \\ [ Formula 11 ] & \\ {{\sum }^{s}}_{s = 1} {h}_{s} = H & ( 10 )\end{matrix}$$

In order to calculate the optimal solution of the time hₛ allocated to the learning items that satisfies Formula (10) and maximizes the evaluation value G of Formula (9), a method (naive method) of selecting the solution from results obtained by calculating all combinations and dynamic programming using a greedy algorithm and a divide-and-conquer method can be used.

(Weak Point Overcoming Mode)

In a weak point overcoming mode, an allocation of hₛ that maximizes the evaluation value G defined in Formula (11) with the condition in Formula (10) is calculated so that the difference between the learning item s and a threshold Mₛ decreases. At this time, G is not considered when the understanding level of the user j exceeds the threshold Mₛ. As the threshold Mₛ, an average understanding level.

θ̅ₛ [Formula 12]

of the plurality of users can be used for each learning item s.

$$\begin{matrix}[ Formula 13 ] & \\ G = {\sum }_{s = 1}^{s} {( {f}_{θ js} ( {t}_{0} + {h}_{s} ) - {M}_{s} )}_{2} {f}_{θ js} ( {t}_{0} + {h}_{s} ) - {M}_{s} < 0 & ( 11 ) \\ [ Formula 14 ] & \\ {\sum }_{s = 1}^{s} {h}_{s} = H & ( 10 )\end{matrix}$$

In order to calculate the optimal solution of the time hₛ allocated to the learning items that satisfy Formula (10) and maximizes the evaluation value G in Formula (11), a method (naive method) of selecting the solution from results obtained by calculating all combinations and dynamic programming using a greedy algorithm and a divide-and-conquer method can be used.

(Subject Weighting Mode)

When a subject weighting mode is selected, an allocation of hₛ that maximizes the evaluation value G defined in Formula (12) with the condition in Formula (10) is calculated in order to maximize the understanding level while respecting the will of the user j for learning. Weighting factors for the learning items are represented by Kₛ. When a subject weighting parameter included in the schedule generation parameter is input, the subject weighting parameter can be used for Kₛ. When the subject weighting parameter is not input, the number of days for which the question of each learning item is learned can be used instead of the weighting parameter by referring to the information indicating the learning history of the user j.

$$\begin{matrix}[ Formula 15 ] & \\ G = {\sum }_{s = 1}^{s} {K}_{s} ( {f}_{θ js} ( {t}_{0} + {h}_{s} ) - {f}_{θ js} ( {t}_{0} ) ) & ( 12 ) \\ [ Formula 16 ] & \\ {\sum }_{s = 1}^{s} {h}_{s} = H & ( 10 )\end{matrix}$$

In order to calculate the optimal solution of the time hₛ allocated to the learning items that satisfy Formula (10) and maximizes the evaluation value G in Formula (12), a method (naive method) of selecting the solution from results obtained by calculating all combinations and dynamic programming using a greedy algorithm and a divide-and-conquer method can be used.

<4-4 Calculation of Time Allocated to Learning Items when Learning Forgetting Rate is Included>

When a learning forgetting rate α by which the learning content starts to be forgotten each day is presumed to be obtained, the maximizing allocation time can be calculated by substituting an apparent learning time h′ₛ that considers the learning forgetting rate in Formula (9), Formula (11), and Formula (12) defining the evaluation value G in 4-3 described above in place of hₛ. At this time, h′ₛ is defined by Formula (13). The number of days counted from, the deadline is represented by d, the number of days from the deadline to the current day or the first day of the target period is represented by D_{T}, the apparent learning time on the d-th day counted from the deadline for the learning item s considering the learning forgetting rate is represented by h′_{s,d}, the learning time on the d-th day counted from the deadline for the learning item s is represented by h_{s,d}, and the total time specified by the unoccupied schedule for each day on the d-th day counted from the deadline is represented by H_{d}. Further, h_{s,d} and H_{d} satisfy Formula (14) and Formula (15).

$$\begin{matrix}[ Formula 17 ] & \\ {h}_{s} = {\sum }_{d = 1}^{{D}_{τ}} {h}_{s , d} = {\sum }_{d = 1}^{{D}_{τ}} {( 1 - a )}^{d} {h}_{s , d} & ( 13 ) \\ [ Formula 18 ] & \\ {\sum }_{s = 1}^{s} {h}_{s , d} = {H}_{d} & ( 14 ) \\ [ Formula 19 ] & \\ {\sum }_{d = 1}^{{D}_{τ}} {H}_{d} = H & ( 15 )\end{matrix}$$

In order to calculate the optimal solution of the time h_{s,d} allocated to the learning items for each day that satisfies Formula (14) and Formula (15) and maximizes the evaluation value G defined by any one of Formula (9), Formula (11), and Formula (12) in which h′ₛ in Formula (13) is substituted for hₛ, a method (naive method) of selecting the solution from results obtained by calculating all combinations and dynamic programming using a greedy algorithm and a divide-and-conquer method can be used.

<4-5 Schedule Generation>

The learning schedule generation section 114 generates a learning schedule on the basis of the learning time hₛ allocated to the learning items s. The schedule generation method includes the following methods.

(Method 1)

A method is which the learning items s are arranged in the order from items with the largest learning time hₛ and the unoccupied time input by the user j is filled in the order from the earliest date.

(Method 2)

A method in which the dates are rearranged in the order from the date of which unoccupied time input by the user j is the longest and the learning time hₛ is allocated to the schedule in the order from the largest learning time hₛ.

(Method 3)

A method in which s is arranged in the order from the largest understanding level improvement presumed to be obtained when the learning time hₛ is spent defined in Formula (16), and the unoccupied time input by the user j is filled in the order from the earliest date.

[Formula 20]

f_{θ}_{_{j,s}}(t₀+hₛ)−f_{θ}_{_{j,s}}(t₀) (16)

(Method 4)

A method in which s is arranged in the order from the smallest understanding level improvement presumed to be obtained when the learning time hₛ is spent defined in Formula (16), and the unoccupied time input by the user j is filled in the order from the earliest date.

(Effects)

(1) By generating the understanding level transition model with use of an indication in which the daily understanding level of the user j that is the learning history is reflected, the change of the understanding level of the user j over time can be reflected in the generated understanding level transition model. By using the learning schedule generated as above, the user j can accurately estimate the necessary learning time for achieving the goal, for example.

In the understanding level transition model, the objective difficulty level calculated with use of the problem answer data according to the plurality of users for the problem answered by the user j can be reflected.

(2) By using the generated learning schedule, the user can perform learning that maximizes the total improvement degree of the understanding level for each learning item, and learning that causes the understanding level of the user for each learning item to become as closer to the understanding level set in advance as possible within a limited learnable time. In this way, the learning effect of the user in certain periods of time such as units of weeks or months can be maximized toward the purpose.

(3) In the generated learning schedule, the daily change of the understanding level of the user j due to the learning forgetting rate for each day can be reflected.

(4) In the generated learning schedule, the learning item of which understanding level improvement degree at the time of learning is large can be learned in a prioritized manner, or the learning item of which understanding level improvement degree is large at the time of learning can be learned in a period that is as late as possible, to thereby cause the forgetting of the learning item to be difficult, for example.

In the learning schedule, the learning item of which amount of time allocated to the learning is large can be learned in a prioritized manner, or the learning item of which amount of time allocated to the learning is large can be learned in a period that is as late as possible, to thereby cause the forgetting of the learning item to be difficult, for example.

### Other Embodiment

The present invention is not limited to Embodiment 1. For example, in Embodiment 1, description in which the learning schedule generation apparatus acquires the question answer data and the question data has been made. However, for example, when question answer data including the attribute information of the question such as the subject, the target grade, the unit, the teaching material name, and the number of choices to which the question answered by the user corresponds is transmitted, the learning schedule generation apparatus does not necessarily need to acquire the question data as that described in Embodiment 1.

In the question difficulty level calculation processing and the time-series understanding level calculation processing of the user, the information on the time taken by the user to answer the question, the information on the content of the answer by the user according to the question, and the like included in the question answer data may be used, for example. As described above, the formula and the like described in Embodiment 1 are merely an example, and similar processing may be performed with corresponding other methods.

The learning contents are not limited to curriculums handled in elementary schools, junior high schools, high schools, and the like, and include learning in employee training and life-long learning, and the present invention can be applied to cases of teaching a musical instrument and karaoke singing, for example. An embodiment for playing the musical instrument and singing karaoke is as follows, for example.

The question answer data acquisition section 111 acquires answer data indicating whether the musical instrument is played well generated from recorded sound data and records the answer data on the answer data storage section 121. Musical score data is saved in the question data storage section 122. As the answer data to be used, the control unit 11 can include an answer data generation section, the recorded sound data can be converted to pitch (interval) data in the answer data generation section by the method described in NPL 4, and the right/wrong determination with respect to the musical score data can be performed, for example. The difficulty level of the entire musical piece, and the difficulty level in small units of bars and notes are calculated in the question difficulty level calculation section 112 on the basis of the above, and are stored in the question difficulty level storage section 123. The learning level of the user and the question difficulty level calculated in the process can be used to recommend the next musical piece to be played and extract and teach a difficult portion of the musical piece.

For the configurations and the like of the data stored in the learning schedule generation apparatus and other storage sections can also embodied while the configurations and the like are modified in various manners without departing from the gist of the present invention.

In other words, the present invention is not strictly limited to Embodiment 1, and the components can be embodied while the components are modified without departing from the gist thereof in an embodiment stage. Various inventions can be formed by properly combining a plurality of components disclosed in Embodiment 1. For example, some components maybe removed from all the components described in Embodiment 1. Components in different embodiments may be combined, as appropriate.

### REFERENCE SIGNS LIST

1 Learning schedule generation apparatus
11 Control unit
111 Question answer data acquisition section
112 Question difficulty level calculation section
113 Understanding level transition model generation section
1131 Time-series understanding level calculation section
1132 Model generation section
114 Learning schedule generation section
115 Learning schedule output section
12 Storage unit
121 Answer data storage section
122 Question data storage section
123 Question difficulty level storage section
124 User learning history storage section
125 Schedule generation parameter storage section
126 Understanding level transition model storage section
127 Learning schedule storage section
13 Communication interface unit
tTM Teacher terminal
sTM1 to sTMn Student terminal
NW Communication network

1. A learning schedule generation apparatus, comprising:
a processor; and
a storage medium having computer program instructions stored thereon, when executed by the processor, perform to:
generate an understanding level transition model according to a user on basis of information indicating a learning history of the user including identification information of a question answered by the user and information on a timing at which the question is answered by the user, and information indicating a difficulty level of the question; and generates a learning schedule of the user on basis of the generated understanding level transition model.

2. The learning schedule generation apparatus claim 1, wherein the computer program instructions further perform to acquire question answer data including identification information of a question answered by a plurality of users and information on whether answers by the plurality of users in the question are right or wrong; and calculates the difficulty level of the question on basis of the information on whether the answers by the plurality of users in the question are right or wrong included in the acquired question answer data.

3. The learning schedule generation apparatus according to claim 1, wherein: the information indicating the learning history further includes identification information of a learning item corresponding to the question; and the computer program instructions further perform generates an understanding level transition model indicating a time transition of an understanding level of the user for the learning item for each learning item; and calculates time allocated to learning of each learning item that maximizes a total degree of improvement of the understanding level of the user for each learning item on basis of a degree of improvement of the understanding level of the user with respect to learning time for each learning item indicated by the generated understanding level transition model for each learning item, and information indicating learnable time of the user set in advance; and generates a learning schedule of the user on basis of the calculated time allocated to the learning of each learning item.

4. The learning schedule generation apparatus according to claim 1, wherein: the information indicating the learning history further includes identification information of a learning item corresponding to the question; and the computer program instructions further perform to generate an understanding level transition model indicating a time transition of an understanding level of the user for the learning item for each learning item; and calculates time allocated to learning of each learning item so as to minimize a total difference between the understanding level of the user for each learning item and a goal understanding level set in advance on basis of an understanding level after improvement of the understanding level of the user with respect to learning time for each learning item indicated by the generated understanding level transition model for each learning item, and information indicating learnable time of the user set in advance; and generates a learning schedule of the user on basis of the calculated time allocated to the learning of each learning item.

5. The learning schedule generation apparatus according to claim 3, wherein: the information indicating the learnable time of the user set in advance includes information on learnable time for the user for each day set in advance; and the computer program instructions further perform to calculate time allocated to the learning of each learning item for each day further on basis of a value of a learning forgetting rate for each day and information on the learnable time of the user for each day set in advance; and generates the learning schedule of the user on basis of the calculated time allocated to the learning of each learning item for each day.

6. The learning schedule generation apparatus according to claim 3, wherein the computer program instructions further perform to calculate an understanding level improvement degree presumed to be obtained when the calculated time allocated to the learning of each learning item is spent on the learning with use of the generated understanding level transition model of the learning item for each learning item; and generates the learning schedule of the user on basis of the understanding level improvement degree that is presumed to be obtained when the time allocated to the learning of each learning item is spent on the learning and that is calculated for each learning item.

7. A learning schedule generation method executed by a learning schedule generation apparatus comprising: generating an understanding level transition model according to a user on basis of information indicating a learning history of the user including identification information of a question answered by the user and information on a timing at which the question is answered by the user, and information indicating a difficulty level of the question; and generating a learning schedule of the user on basis of the generated understanding level transition model.

8. A non-transitory computer readable medium including instructions executable by one or more processors to:
generate an understanding level transition model according to a user on basis of information indicating a learning history of the user including identification information of a question answered by the user and information on a timing at which the question is answered by the user, and information indicating a difficulty level of the question; and
generate a learning schedule of the user on basis of the generated understanding level transition model.
